(19) United States
(12) Patent Application Publication
(10) Pub. No.: US 2007/0182668 A1
(43) Pub. Date: Aug. 9, 2007

(54) Method of driving a plasma display panel

(76) Inventor: Tae-Kyoung Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/702,063

(22) Filed: Feb. 5, 2007

(30) Foreign Application Priority Data
Feb. 7, 2006 (KR) 10-2006-0011741

(51) Int. Cl. G09G 3/28

(52) U.S. Cl. 345/63

(57) ABSTRACT

A method of driving a plasma display panel (PDP) may perform a stable sustain discharge. The PDP may include discharge cells in areas where display electrodes cross address electrodes. The discharge cells may be divided into a plurality of groups in a direction of the address electrodes. A unit frame used to express an image may be divided into a plurality of subfields. Each subfield may be divided into a mixing drive period, including a group address period and a group sustain period, and a correction sustain period for realizing gray scale. During the group sustain periods, an application period of a first voltage in a subfield having a minimum gray-level weight may be longer than an application period of the first voltage in subfields having larger gray-level weights. The correction sustain period may include a common sustain period and a selection sustain period.

### BACKGROUND OF THE INVENTION

1. Field of the Invention

The present invention relates to a method of driving a plasma display panel. More particularly, the present invention relates to a method of driving a plasma display panel to equally perform a sustain discharge in the upper and lower part of the panel.

2. Description of the Related Art

Plasma display devices, which have generally replaced conventional cathode ray tube (CRT) display devices, uses plasma generated by gas discharge to display characters or images. A plasma display panel (PDP) may include two substrates, and a discharge gas may be provided between the two substrates. Electrodes may be provided on each of the two substrates. When discharge voltages are applied to the electrodes, vacuum ultraviolet (VUV) radiation may be generated by discharge, and the VUV radiation may excite phosphor formed in a predetermined pattern to emit visible light, thus displaying images.

In an address display separation (ADS) method, a unit frame used to express an image may be divided into eight subfields SF1 through SF8 in order to display time division gray levels. Each of the subfields SF1 through SF8 may be divided into a reset period, an address period, and a sustain-discharge period.

In the reset period, all discharge cells may be initialized. For example, when using a three electrode PDP, in the reset period, a rising ramp pulse and a falling ramp pulse may be applied to scan electrodes, and a bias voltage may be applied to sustain electrodes after the falling ramp pulse is applied to the scan electrodes, so that a reset discharge may be performed in discharge cells.

In each of the address periods, addressing may be sequentially performed from the upper part of a panel to the lower part of the panel, and a discharge cell may be selected to be turned on and off from among all the discharge cells. For example, when using a three electrode PDP, in the address period, a scan pulse may be sequentially applied to the scan electrodes from the upper part of the panel to the lower part of the panel, and a display data signal may be applied to address electrodes in accordance with the scan pulse, so that an address discharge may be performed in a discharge cell that is selected to be turned on. The wall charges of the discharge cells may be set to perform sustain discharge in a next sustain period.

The brightness of a PDP is proportional to a number of sustain discharges applied during the sustain period of a unit frame. When the unit frame is divided into the eight subfields SF1 through SF8, and the brightness of the unit frame is divided into 256 gray-levels, gray-level weights may be sequentially allocated to each of the eight subfields SF1 through SF8 at rates of 1, 2, 4, 8, 16, 32, 64, and 128, and the sustain discharge may be performed in accordance with the number of the allocated gray-level weights. For example, if the brightness of the 133rd gray-level is to be displayed, discharge cells may be addressed at the first subfield SF1, the third subfield SF3, and the eighth subfield SF8 to perform the sustain discharge. For example, when using a three electrode PDP, in the sustain period, a sustain pulse may alternately be applied to the scan electrodes and the sustain electrodes so that the sustain discharge may be performed by the allocated gray-level weight.

In the ADS driving method, a period between the address discharge and the sustain discharge may be different in the upper and lower part of the panel. That is, the period may be shorter in the lower part of the panel than in the upper part of the panel, so that the sustain discharge between the upper and lower part of the panel may have a different discharge characteristic or sustain discharge intensity. Therefore, the sustain discharge may not be equally performed. This inequality is worsened in a high definition PDP.

### SUMMARY OF THE INVENTION

The present invention is therefore directed to a method of driving a plasma display panel (PDP), which substantially overcomes one or more the limitations and disadvantages of the related art.

It is a feature of an embodiment of the present invention to provide a method of driving a PDP having a stable sustain discharge.

It is another feature of an embodiment of the present invention to provide a method of driving a PDP reducing a period between address discharge and sustain discharge.

It is yet another feature of an embodiment of the present invention to provide a method of driving a PDP insuring sufficient priming of discharge cells.

At least one of the above and other features and advantages may be realized by providing a method of driving a plasma display panel having display electrodes, address electrodes crossing the display electrodes, and discharge cells in areas where the display electrodes cross the address electrodes, the discharge cells being divided into a plurality of discharge cell groups in a direction of the address electrodes to drive the plasma display panel in groups, the method including dividing a unit frame used to express an image into a plurality of subfields, and dividing each subfield into a mixing drive period and a correction sustain period. The mixing drive period may include group address periods in which a discharge cell is selected to be turned on from the discharge cell groups, and group sustain periods in which a certain number of sustain discharges is performed between the group address periods, sustain discharges being performed by applying a sustain pulse alternating between a first voltage and a second voltage. The correction sustain period may correct the number of sustain discharges in the discharge cell groups so as to perform a sustain discharge in accordance with a gray-level weight allocated to each of the subfields throughout the subfields. An application period of the first voltage in group sustain periods of a subfield having a minimum gray-level weight may be longer than an application period of the first voltage in group sustain periods of subfields having higher gray-level weights.

An application period of the first voltage in the group sustain periods of a subfield having a second smallest gray-level weight may be allocated to be longer than an application period of the first voltage in group sustain periods of subfields having higher gray-level weights.

During the group sustain periods, a sustain pulse alternating between the second voltage and the first voltage may be applied to the display electrodes, and applying the second voltage to the address electrodes.

The display electrodes may include sustain electrodes and scan electrodes spaced apart from and parallel to each other.

During the group address periods, a scan pulse having a third voltage and a fourth voltage having a lower electric potential than the third voltage may be sequentially applied to the scan electrodes of each of the discharge cell groups, a positive fifth voltage may be applied to the sustain electrodes of each of the discharge cell groups, and a display data signal having a positive sixth voltage may be applied to the address electrodes of each of the discharge cell groups in accordance with the scan pulse.

The correction sustain period may include a common sustain period in which the same number of the sustain discharge is performed in each of the discharge cell groups, and a selection sustain period in which the sustain discharge is selectively performed in each of the discharge cell groups. The common sustain period may occur before or after the selection sustain period.

During the common sustain period, a sustain pulse alternating between the first voltage and the second voltage may be applied to the scan electrodes of each of the discharge cell groups, and a sustain pulse alternating between the second voltage and the first voltage may be applied to the sustain electrodes of each of the discharge cell groups.

During the selection sustain period, the sustain pulse alternating between the first voltage and the second voltage may be selectively applied to the scan electrodes of each of the discharge cell groups, and the sustain pulse alternating between the second voltage and the first voltage may be applied to the sustain electrodes of each of the discharge cell groups.

During the selection sustain period, the first voltage and a fourth voltage lower than the first voltage may be applied to the scan electrodes of one of the discharge cell group in which the sustain discharge is not selectively performed, the sustain pulse alternating between the first voltage and the second voltage may be applied to the scan electrodes of the other discharge cell groups, and the sustain pulse alternating between the second voltage and the first voltage may be applied to the sustain electrodes of each of the discharge cell groups. During the common sustain period, the sustain pulse alternating between the first voltage and the second voltage may be applied to the scan electrodes of each of the discharge cell groups, and the sustain pulse alternating between the second voltage and the first voltage may be applied to the sustain electrodes of each of the discharge cell groups.

Each subfield may include a reset period that initializes all the discharge cells before the mixing drive period. During the reset period, a rising pulse that increases from the first voltage by a third voltage to a fourth voltage and a falling pulse that decreases from the first voltage to a fifth voltage may be applied to the scan electrodes of each of the discharge cell groups, a positive sixth voltage may be applied to the sustain electrodes of each of the discharge cell groups when the falling pulse is applied, and the second voltage may be continuously applied to the address electrodes.

The second voltage may be a ground voltage. The sustain discharge may be performed once in the group sustain periods. The plurality of groups may be two.

At least one of the above and other features and advantages may be realized by providing a method of driving a plasma display panel having display electrodes, address electrodes crossing the display electrodes, and discharge cells in areas where the display electrodes cross the address electrodes, the discharge cells being divided into a plurality of discharge cell groups in a direction of the address electrodes to drive the plasma display panel by the groups, the method including dividing a unit frame used to express an image into a plurality of subfields, and dividing each subfield into a mixing drive period and a correction sustain period. The mixing drive period may include group address periods in which a discharge cell is selected to be turned on from the discharge cell groups, and group sustain periods in which a certain number of sustain discharges is performed between the group address periods, sustain discharges being performed by applying a sustain pulse alternating between a first voltage and a second voltage. The correction sustain period may correct the number of sustain discharges in the discharge cell groups so as to perform a sustain discharge in accordance with a gray-level weight allocated to each of the subfields throughout the subfields. The correction sustain period may include a common sustain period in which the same number of the sustain discharge is performed in each of the discharge cell groups, and a selection sustain period in which the sustain discharge is selectively performed in each of the discharge cell groups.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an arrangement of electrodes of a plasma display panel (PDP) to which a method of driving the PDP is applied according to an embodiment of the present invention;

FIG. 2 illustrates a timing diagram of an address display mixing (ADM) method;

FIG. 3 illustrates an operation of a first subfield illustrated in FIG. 2;

FIG. 4 illustrates an operation of a fourth subfield illustrated in FIG. 2;

FIG. 5 illustrates a timing diagram of a driving signal of the fourth subfield illustrated in FIG. 4 according to an embodiment of the present invention;

FIG. 6 illustrates a timing diagram of a driving signal of the fourth subfield illustrated in FIG. 4 according to another embodiment of the present invention;

FIG. 7 illustrates timing diagrams of a driving signal used to drive a plasma display panel according to an embodiment of the present invention; and

FIG. 8 illustrates a timing diagram of a driving signal used to drive a plasma display panel according to another embodiment of the present invention.

### DETAILED DESCRIPTION OF THE INVENTION

Korean Patent Application No. 10-2006-0011741, filed on Feb. 7, 2006, in the Korean Intellectual Property Office, and entitled: “Method of Driving Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by ultraviolet light that impinges thereon, and is not intended be limited to materials the undergo light emission through any particular mechanism or over any particular time frame. Like reference numerals refer to like elements throughout.

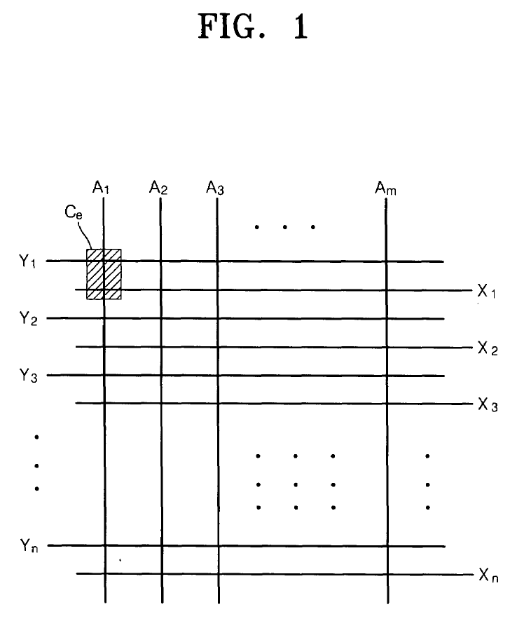

FIG. 1 illustrates an arrangement of electrodes of a plasma display panel (PDP) to which a method of driving the PDP is applied according to an embodiment of the present invention.

Referring to FIG. 1, scan electrodes Y1 through Yn and sustain electrodes X1 through Xn may be parallel to each other, and address electrodes A1 through Am may cross the scan electrodes Y1 through Yn and the sustain electrodes X1 through Xn. Discharge cells may be defined in an area where the scan and sustain electrodes cross the address electrodes. Details of the PDP structure discussed below for completeness, but are not illustrated in FIG. 1.

The address electrodes A1 through Am may be formed in a front surface of a rear substrate in a regular pattern. A rear dielectric layer may be formed on the address electrodes A1 through Am. Barrier ribs may be formed on the rear dielectric layer and parallel to the address electrodes A1 through Am. The barrier ribs may partition a discharge region of each of discharge cells, and may prevent an optical interference between the discharge cells. Phosphor layers may be formed in the front of the rear dielectric layer on the address electrodes A1 through Am between the barrier ribs, and may sequentially include a red light-emitting phosphor layer, a green light-emitting phosphor layer, and a blue light-emitting phosphor layer.

The sustain electrodes X1 through Xn and the scan electrodes Y1 through Yn may be formed in the rear of a front substrate in a regular pattern and may cross the address electrodes A1 through Am. Each of the sustain electrodes X1 through Xn and the scan electrodes Y1 through Yn may include transparent electrodes formed of a transparent conductive material, e.g., indium tin oxide (ITO), and metal electrodes (bus electrodes) formed of a metallic material to increase conductivity. A front dielectric layer may be cover the sustain electrodes X1 through Xn and the scan electrodes Y1 through Yn. A protective layer, e.g., an MgO layer, may cover the front dielectric layer to protect the PDP. A discharge gas may be sealed in a discharge space between the front and rear substrates.

The structure of the PDP as described above is just an example. The structure of the PDP to which the method of driving the PDP of the current embodiment of the present invention is not limited thereto. That is, while a three electrode PDP is illustrated in the current embodiment of the present invention, the method of driving the PDP of the current embodiment of the present invention may be applied to a two electrode PDP having single display electrodes, e.g., the scan electrodes Y1 through Yn, and the address electrodes A1 through Am.

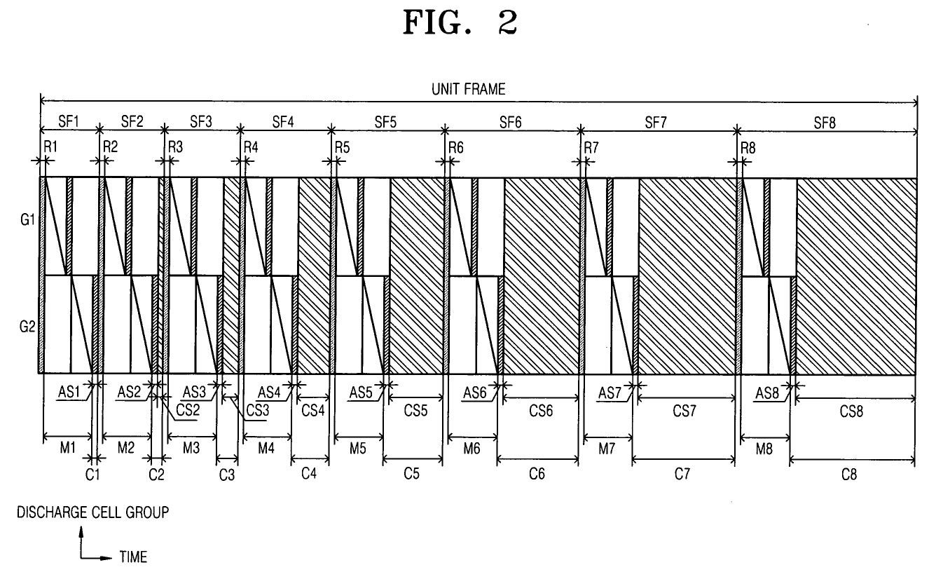

FIG. 2 illustrates a timing diagram of an address display mixing (ADM) method in accordance with an embodiment of the present invention.

Referring to FIG. 2, the ADM method may divide discharge cells into a plurality of groups from the upper and lower part of a panel, perform addressing group by group, and perform a specific number of sustain discharges in a group where the address is performed. The ADM method may reduce or eliminate differences in sustain discharge in the upper and lower portions of the panel compared with the ADS method discussed above, which addresses the entire panel and then performs sustain discharge.

The ADM method may divide each of eight subfields SF1 through SF8 into reset periods R1 through R8, mixing drive periods M1 through M8, and correction sustain periods C1 through C8. In the reset periods R1 through R8, all the discharge cells may be initialized, and a reset pulse, having a rising pulse and a falling pulse, may be applied to the scan electrodes Y1 through Yn. In the mixing drive periods M1 through M8, a discharge cell to be turned on may be selected by groups of each of the discharge cells. That is, the mixing drive periods M1 through M8 may be divided into address periods by groups in which addressing is performed, and at least one sustain period by groups in which a specific number of sustain discharges is performed in the selected discharge cell between the address periods by groups. In the correction sustain periods C1 through C8, the sustain discharge may be selectively performed by groups of each of the discharge cells.

The correction sustain periods C1 through C8 may be divided into selection sustain periods AS1 through AS8 in which a difference between the number of sustain discharges by groups may be corrected, and common sustain periods CS1 through CS8 in which the sustain discharge may be performed in accordance with a number of gray-level weights allocated in each of the subfields throughout the subfields and by the same number with regard to all the groups. The selection sustain periods AS1 through AS8 may be followed by the common sustain periods CS1 through CS8. However, the common sustain periods CS1 through CS8 may be followed by the selection sustain periods AS1 through AS8.

The number of groups may be varied. However, in the embodiment illustrated in FIG. 2, there are two groups. The discharge sustain may be performed once in the sustain periods by groups. However, the discharge sustain may be performed several times according to design specifications. A unit frame may be divided into eight subfields in the current embodiment of the present invention. However, the present invention is not limited thereto. A variety of modifications of the gray-level weights may be allocated to each of the subfields.

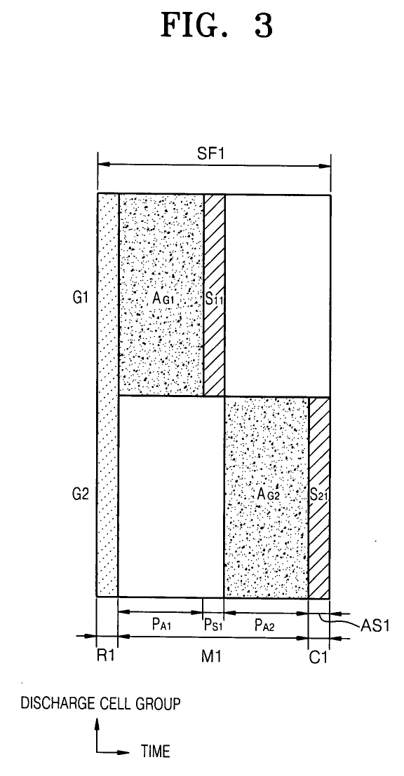

FIG. 3 illustrates a timing diagram of an operation of a first subfield SF1 illustrated in FIG. 2.

In the reset period R1, a reset pulse having a rising pulse and a falling pulse may be applied to the scan electrodes Y1 through Yn, a bias voltage Vb may be applied to the sustain electrodes X1 through X8 from the application of the falling pulse, a reset discharge may be performed, and wall charges of all the discharge cells may be equally initialised after the reset period R1 ends.

In the mixing drive period M1, a first discharge cell group G1 may perform an address discharge AG1 in a first group address period PA1. In a first group sustain period PS1, the first discharge cell group G1 may perform sustain discharge S11. In a second group address period PA2, a second discharge cell group G2 may perform an address discharge AG2.

In the correction sustain period C1, e.g., the selection sustain period AS1, the second discharge cell group G2 may perform sustain discharge S21. If the gray-level weight of the first subfield SF1 is 1, sustain discharge may be performed once throughout the first subfield SF1. Thus, the first discharge cell group G1 may perform sustain discharge once in the first group sustain period PS1, and the second group discharge cell group G2 may perform sustain discharge once in the selection sustain period AS1, thereby requiring no common sustain periods CS1 through CS8.

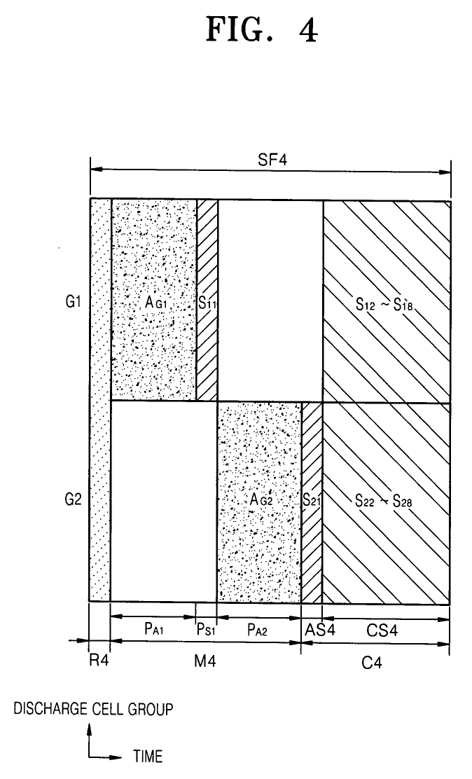

FIG. 4 illustrates an operation of a fourth subfield SF4 illustrated in FIG. 2.

In the reset period R4, a reset pulse having a rising pulse and a falling pulse may be applied to the scan electrodes Y1 through Yn, a bias voltage Vb may be applied to the sustain electrodes X1 through X8 from the application of the falling pulse, a reset discharge may be performed, and wall charges of all the discharge cells may be equally initialised.

In the mixing drive period M4, the first discharge cell group G1 may perform an address discharge AG1 in the first group address period PA1. In the first group sustain period PS1, the first discharge cell group G1 may perform sustain discharge S11. In the second group address period PA2, the second discharge cell group G2 may perform the address discharge AG2.

During a selection sustain period AS4 in a correction sustain period C4, the second discharge cell group G2 may perform sustain discharge S21. If the gray-level weight of the fourth subfield SF4 is 8, the sustain discharge may be performed eight times throughout the fourth subfield SF4. Therefore, during a common sustain period CS4 of the correction sustain period C4, the first discharge cell group G1 may perform sustain discharge seven times, i.e., sustain discharges S12 through S18, and the second discharge cell group G2 may perform sustain discharge seven times, i.e., sustain discharges S22 through S28.

The common sustain period CS4 may be followed by the selection sustain periods AS4 in the current embodiment of the present invention. However, the selection sustain periods AS4 may be followed by the common sustain period CS4. The subfields other than the first and fourth subfields SF1 and SF4 may be operated as described above.

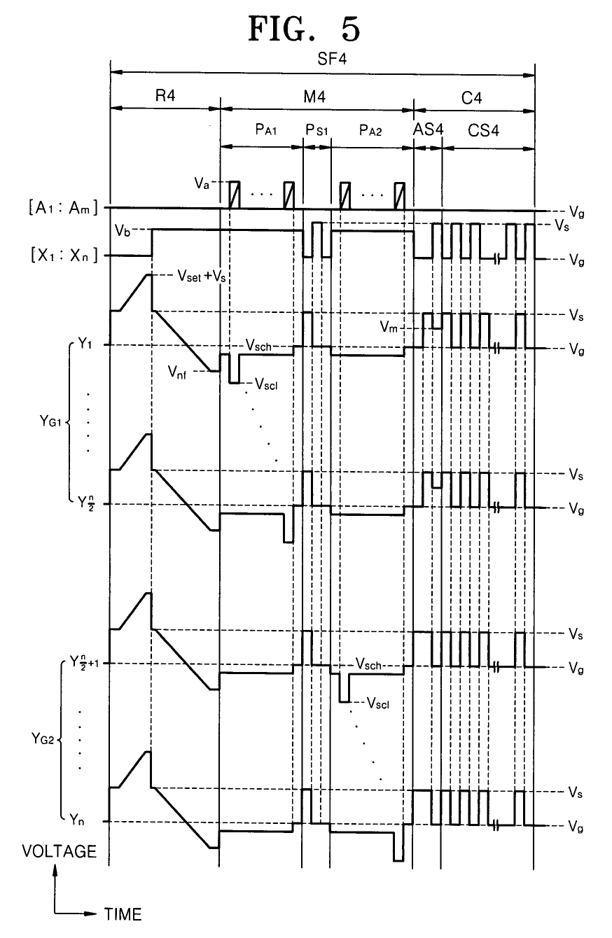

FIG. 5 illustrates a timing diagram of a driving signal of the fourth subfield SF4 illustrated in FIG. 4 according to an embodiment of the present invention.

Referring to FIG. 5, the discharge cells may be divided into two groups in a direction of the upper and lower parts of a panel, i.e., in a direction of address electrodes. The first discharge cell group G1 may include scan electrodes Y1 through Yn/2, and the second discharge cells group G2 may include scan electrodes Yn/2+1 through Yn.

In a reset period R4, a reset pulse may be applied to all scan electrodes Y1 through Yn in order to equally distribute wall charges of all the discharge cells. The reset pulse may include a rising pulse that increases from a first voltage, e.g., a sustain voltage Vs, by a seventh voltage, e.g., a reset voltage Vset, to an eighth voltage, e.g., a sum of the reset voltage and the sustain voltage Vset+Vs, and a falling pulse that decreases from the sustain discharge voltage Vs to a ninth voltage, e.g., a negative voltage Vnf. A fifth voltage, e.g., a bias voltage Vb, may be applied to all sustain electrodes X1 through Xn from the application of the falling pulse. A second voltage, e.g., a ground voltage Vg, may be applied to all address electrodes A1 through Am. The bias voltage Vb may have the same magnitude as the sustain discharge voltage Vs.

In the reset period R4, when the rising pulse is applied, a weak discharge may be performed in the discharge cells, accumulating positive wall charges around the scan electrodes Y1 through Yn, and negative wall charges around the sustain electrodes X1 through Xn and the address electrodes A1 through Am. Also, when the falling pulse is applied, the weak discharge may be performed in the discharge cells, the positive wall charges accumulated around the scan electrodes Y1 through Yn may be erased, and negative wall charges accumulated around the sustain electrodes X1 through Xn and the address electrodes A1 through Am may be erased. Therefore, the wall charges may be equally distributed in all the discharge cells.

An address discharge and a sustain discharge may be simultaneously performed in a mixing drive period M4.

In the first group address period PA1, addressing, i.e., the address discharge, may be sequentially performed in the first discharge cell group G1. That is, a scan pulse sequentially having a third voltage, e.g., a scan high voltage Vsch, and a fourth voltage, e.g., a scan low voltage Vscl, may be applied to the first group of scan electrodes Y1 through Yn/2. A display data signal having a sixth voltage, e.g., an address voltage Va, may be applied to the address electrodes A1 through Am in accordance with the scan pulse. The bias voltage Vb may be continuously applied to the sustain electrodes X1 through Xn. The address discharge may be performed between the address electrodes A1 through Am and the scan electrodes Y1 through Yn in the discharge cells through the display data signal and the scan pulse so that the negative wall charges may accumulate around the sustain electrodes X1 through Xn and the positive wall charges may accumulate around the scan electrodes Y1 through Yn. During the first group address period PA1, the scan high voltage Vsch may be continuously applied to the second groups of scan electrodes Yn/2+1 through Yn.

In the first group sustain period PS1, the sustain discharge may be performed once in the first discharge cell group G1. The sustain voltage Vs and the ground voltage Vg may be sequentially applied to the scan electrodes Y1 through Yn. The ground voltage Vg and the sustain voltage Vs may be sequentially applied to the sustain electrodes X1 through Xn in accordance with a period in which the sustain voltage Vs and the ground voltage Vg are sequentially applied to the scan electrodes Y1 through Yn.

When the sustain voltage Vs is applied to the scan electrodes Y1 through Yn, and the ground voltage Vg is applied to the sustain electrodes X1 through Xn, positive wall charges may accumulate around the scan electrodes Y1 through Yn and negative wall charges may accumulate around the sustain electrodes X1 through Xn of the discharge cells in which the address discharge is performed, i.e., the first discharge cells group G1, in which the address discharge is performed in the first group address period PA1, so that sustain discharge may be performed when the first voltage Vs is applied to the scan electrodes Y1 through Yn and the ground voltage Vg is applied to the sustain electrodes X1 through Xn. Thereafter, negative wall charges may accumulate around the scan electrodes Y1 through Yn, and positive wall charges may accumulate around the sustain electrodes X1 through Xn. Meanwhile, wall charges do not accumulate around the scan electrodes Y1 through Yn and the sustain electrodes X1 through Xn of the discharge cells in which the address discharge is not performed, i.e., the second discharge cells group G2, in which the address discharge is not performed. Therefore, even if the sustain voltage Vs is applied to the scan electrodes Y1 through Yn, and the ground voltage Vg is applied to the sustain electrodes X1 through Xn, the sustain discharge may not be performed due to an insufficient discharge start voltage. The second discharge cell group G2 may maintain the wall charges initialized in the reset period.

When the ground voltage Vg is applied to the scan electrodes Y1 through Yn, and the sustain voltage Vs is applied to the sustain electrodes X1 through Xn, sustain discharge may be performed in the first discharge cell group G1, so that negative wall charges may accumulate around the sustain electrodes X1 through Xn, and positive wall charges may accumulate around the scan electrodes Y1 through Yn. Although the ground voltage Vg is applied to the scan electrodes Y1 through Yn, and the sustain voltage Vs is applied to the sustain electrodes X1 through Xn, the sustain discharge may not be performed in the second discharge cell group G2.

The sustain discharge performed once may include a sustain discharge performed when the sustain voltage Vs is applied to the scan electrodes Y1 through Yn, and the ground voltage Vg is applied to the sustain electrodes X1 through Xn, and a sustain discharge performed when the ground voltage Vg is applied to the scan electrodes Y1 through Yn, and the sustain voltage Vs is applied to the sustain electrodes X1 through Xn.

In the second group address period PA2, addressing, i.e., the address discharge, may be sequentially performed in the second discharge cell group G2. That is, a scan pulse sequentially having the scan high voltage Vsch and the scan low voltage Vscl may be applied to the second groups of scan electrodes Yn/2+1 through Yn. A display data signal having the address voltage Va may be applied to the address electrodes A1 through Am in accordance with the scan pulse. The bias voltage Vb may be continuously applied to the sustain electrodes X1 through Xn. The address discharge may be performed between the address electrodes A1 through Am and the scan electrodes Y1 through Yn inside the discharge cells through the display data signal and the scan pulse so that negative wall charges may accumulate around the sustain electrodes X1 through Xn and positive wall charges may accumulate around the scan electrodes Y1 through Yn of the second discharge cell group G2. The scan high voltage Vsch may be continuously applied to the first group of scan electrodes Y1 through Yn/2.

The correction sustain period C4 may include the selection sustain period AS4 and the common sustain period CS4. In the selection sustain period AS4, the sustain discharge may be selectively performed in the first and second discharge cell groups G1 and G2. In the mixing drive period M4, the sustain discharge may be performed once in the first discharge cell group G1 but not in the second discharge cell group G2. Therefore, the sustain discharge may be selectively performed in the first and second discharge cell groups G1 and G2 in the selection sustain period AS4. To this end, the sustain voltage Vs and a tenth voltage, e.g., a middle voltage Vm having an electric potential between that of the sustain voltage Vs and the ground voltage Vg, may be sequentially applied to the first groups of scan electrodes Y1 through Yn/2. The sustain voltage Vs and the ground voltage Vg may be sequentially applied to the second group of scan electrodes Yn/2+1 through Yn. The ground voltage Vg and the sustain voltage Vs may be sequentially applied to the sustain electrodes X1 through Xn.

When the ground voltage Vg is applied to the sustain electrodes X1 through Xn, the sustain discharge may be performed by ½ times in the first and second discharge cells groups G1 and G2. When the sustain voltage Vs is applied to the sustain electrodes X1 through Xn, the sustain discharge may not be performed in the first discharge cell group G1 due to the application of the middle voltage Vm, and the sustain discharge may be performed in the second discharge cell group G2. Therefore, in the selection sustain period AS4, the sustain discharge may be performed by ½ times in the first discharge cell group G1, and the sustain discharge may be performed once in the second discharge cell group G2. After the end of the selection sustain period AS4, negative wall charges may accumulate around the scan electrodes Y1 through Yn and positive wall charges may accumulate around the sustain electrodes X1 through Xn of the first discharge cell group G1. Positive wall charges may accumulate around the scan electrodes Y1 through Yn and negative wall charges may accumulate around the sustain electrodes X1 through Xn of the second discharge cell group G2.

In the common sustain period CS4, the sustain discharge may be commonly performed regardless of the first and second discharge cell groups G1 and G2. A sustain pulse sequentially having the sustain voltage Vs and the ground voltage Vg may be applied to the scan electrodes Y1 through Yn, and a sustain pulse sequentially having the ground voltage Vg and the sustain voltage Vs may be applied to the sustain electrodes X1 through Xn. That is, the sustain pulses may alternately be applied to the scan electrodes Y1 through Yn and the sustain electrodes X1 through Xn.

When the sustain voltage Vs is first applied to the scan electrodes Y1 through Yn in the common sustain period CS4, since negative wall charges are accumulated around the scan electrodes Y1 through Yn and positive wall charges are accumulated around the sustain electrodes X1 through Xn, the sustain discharge may not be substantially performed by ½ times in the first discharge cell group G1. In contrast, the sustain discharge may be performed by ½ times in the second discharge cell group G2, since positive wall charges are accumulated around the scan electrodes Y1 through Yn and negative wall charges are accumulated around the sustain electrodes X1 through Xn. When the ground voltage Vg is applied to the scan electrodes Y1 through Yn in the common sustain period CS4, since positive wall charges are accumulated around the scan electrodes Y1 through Yn and negative wall charges are accumulated around the sustain electrodes X1 through Xn, the sustain discharge may be performed by ½ times in the first and second discharge cell groups G1 and G2. The sustain pulse may be continuously applied to perform the sustain discharge by the number of the gray-level weights allocated to the fourth subfield SF4 based on the number of the sustain discharges performed in the first group sustain period PS1 and the selection sustain period AS4.

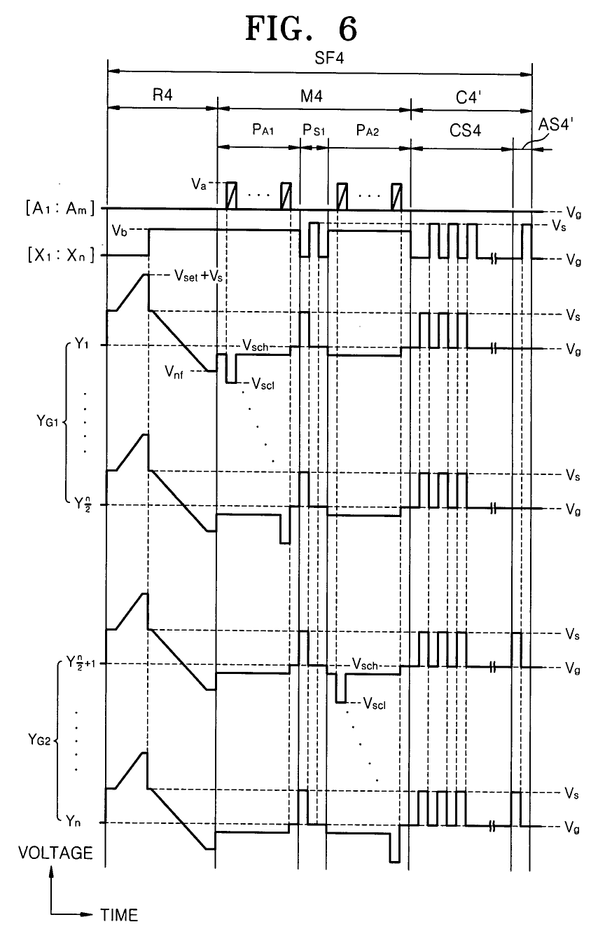

FIG. 6 illustrates a timing diagram for explaining another driving signal of the fourth subfield SF4 illustrated in FIG. 4 according to another embodiment of the present invention.

The driving signal illustrated in FIG. 6 is almost identical to the driving signal illustrated in FIG. 5 except that an order of a selection sustain period AS4′ and the common sustain period CS4 is switched in a correction sustain period C4′. Therefore, the reset period R4 and the driving signal in a mixing drive period M4 may be identical to the reset period R4 and the mixing drive period M4 illustrated in FIG. 5. In the correction sustain period C4′, the common sustain period CS4 may be followed by the selection sustain period AS4′.

In the common sustain period CS4, a sustain pulse alternately having the sustain voltage Vs and the ground voltage Vg may be applied to the scan electrodes Y1 through Yn, and a sustain pulse alternately having the ground voltage Vg and the sustain voltage Vs may be applied to the sustain electrodes X1 through Xn. That is, the sustain pulses may be alternately applied to the scan electrodes Y1 through Yn and the sustain electrodes X1 through Xn. Sustain discharge may be performed in each of addressed discharge cells in the first address period PA1 and the second group address period PA2 in the mixing drive period M4. If a gray-level weight of the fourth subfield SF4 is 8 and the sustain discharge is performed eight times, the sustain discharge may be performed seven times in the common sustain period CS4, and once in the first group sustain period PS1 and the selection sustain period AS4′.

Since it is not necessary to perform the sustain discharge in the first discharge cell group G1 in the selection sustain period AS4′, the second ground voltage Vg may be continuously applied to the scan electrodes Y1 through Yn/2 of the first discharge cell group G1. Since the sustain discharge must be performed once more in the second discharge cell group G2, the sustain voltage Vs and the ground voltage Vg may be alternately applied to the scan electrodes Yn/2+1 through Yn of the second discharge cell group G2. The ground voltage Vg and the first voltage Vs may be alternately applied to the sustain electrodes X1 through Xm.

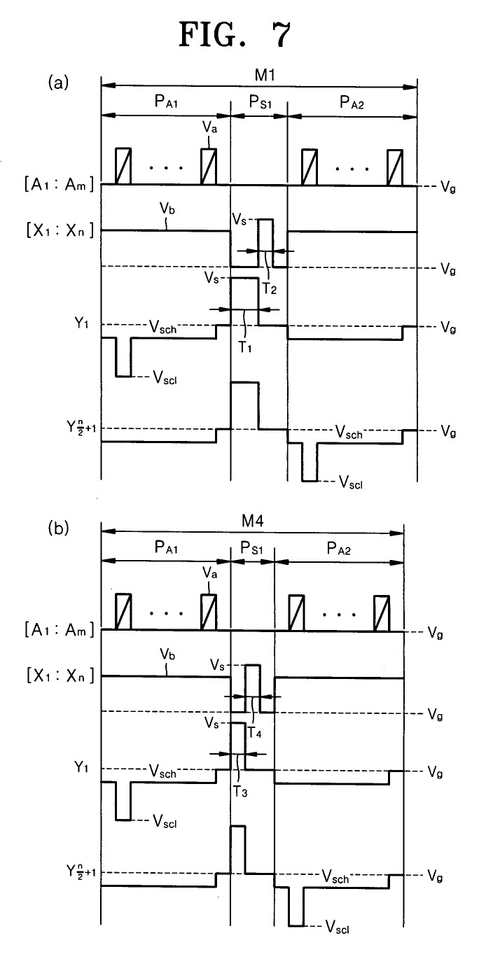

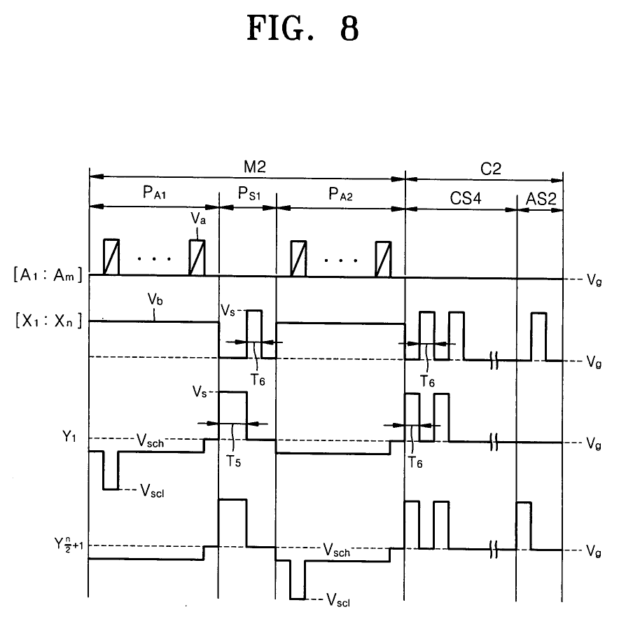

As illustrated in FIGS. 5 and 6, if the first and second discharge cell groups G1 and G2 are addressed and have the sustain period, a pause period between the address discharge and the sustain discharge may be reduced, thereby stabilizing discharge characteristics of the sustain discharge. However, the ADM method may still result in an unequal discharge or a low discharge, since a discharge cell of a subfield to which a small gray-level weight is allocated has fewer priming particles relative to other subfields. To address this problem, a method of driving the PDP will now be described with reference to FIGS. 7 and 8.

Timing diagrams (a) and (b) in FIG. 7 are of a driving signal used to drive a PDP according to an embodiment of the present invention.

Referring to FIG. 7, an ADM method is used to drive the PDP, and an application period of the sustain voltage Vs of a sustain pulse applied to scan electrodes in a subfield to which a minimum weight is allocated may be longer than that of the sustain voltage Vs of a sustain pulse applied to scan electrodes of other subfields so that the problem of a relatively small amount of priming particles of a discharge cell of a subfield having a small number of discharges may be addressed, thereby performing a stable discharge. For example, if a gray-level weight of a first subfield SF1 is 1, which is the minimum weight, an application period of the sustain voltage Vs of the sustain pulse applied to the scan electrodes may be increased.

The timing diagram (a) of FIG. 7 illustrates that the gray-level weight of the first subfield SF1 is 1 in a mixing drive period. The timing diagram (b) of FIG. 7 illustrates that the gray-level weight of the fourth subfield SF4 is 8 in the mixing drive period.

The timing diagrams (a) and (b) of FIG. 7 may have the same first and second group address periods, which is the same as described with reference to FIGS. 5 and 6. Thus, their detailed descriptions will be omitted. The application period of the sustain voltage Vs of the sustain pulse applied to the scan electrodes of the first subfield SF1 is T1, which may be longer than T3 that is an application period of the sustain voltage Vs of the sustain pulse applied to the scan electrodes of the fourth subfield SF4. If an application period of the sustain voltage Vs of a sustain pulse applied to sustain electrodes of the first subfield SF1 is T2, and an application period of the sustain voltage Vs of the sustain pulse applied to the sustain electrodes of the fourth subfield SF4 is T4, T1>T2, and T2=T3=T4. Likewise, the application period of the sustain voltage Vs of the first subfield SF1 may be longer than that of the sustain voltage Vs of other subfield, so that wall charges are much accumulated in the discharge cells, thereby performing a stable sustain discharge. Therefore, an address discharge and the stable sustain discharge may be performed in subfields subsequent to the first subfield SF1.

FIG. 8 illustrates a timing diagram of a driving signal used to drive a plasma display panel according to another embodiment of the present invention.

In the previous embodiment illustrated in FIG. 7, the application period of the sustain voltage Vs of the sustain pulse applied to scan electrodes in a subfield to which a minimum weight is allocated may be longer than that of the sustain voltage Vs of the sustain pulse applied to scan electrodes of other subfields. In addition, in the current embodiment, a first application period of the sustain voltage Vs of a subfield to which a second small gray-level weight is applied may be longer than a second application period of the sustain voltage Vs.

For example, the gray-level weight of the second subfield SF2 may be 2, which is smaller than the gray-level weight of the first subfield SF1.

A mixing drive period M2 and a correction sustain period C2 of the second subfield SF2 will now be described with reference to FIG. 8.

The mixing drive period M2 may be divided into a first group address period PA1, a first group sustain period PS1, and a second group address period PA2. The correction sustain period C2 may be divided into a common sustain period CS2 and a selection sustain period AS2. The first and second group address periods PA1 and P2 are described with reference to FIGS. 5 and 6, and the common sustain period CS2 and the selection sustain period AS2 are described with reference to FIG. 6. Thus, their detailed description will be omitted.

If an application period of the sustain voltage Vs of a sustain pulse applied to the scan electrodes Y1 through Yn is T5 in the first sustain period PS1, an application period of the sustain voltage Vs applied to the sustain electrodes X1 through Xn in the first sustain period PS1 and the scan electrodes Y1 through Yn and the sustain electrodes X1 through Xn in the common sustain period CS2 and the selection sustain period AS2 is T6, it may T5>T6. The sustain discharge is not performed in the first subfield SF1. However, the stable sustain discharge is performed in a discharge cell in which the sustain discharge is performed in the second subfield SF2. Also, even if the sustain discharge is performed in the first subfield SF1, a more stable sustain discharge is performed in the discharge cell in which the sustain discharge is performed in the second subfield SF2.

The effect of the present invention is described below.

First, discharge cells including display electrodes, e.g., pairs of scan electrodes and sustain electrodes, may be grouped, and an address discharge and a sustain discharge may be sequentially performed, so that a period between the address discharge and the sustain discharge may be reduced, and wall charges may be less distributed inside the discharge cells, thereby performing a stable sustain discharge.

Second, when a first voltage of a sustain pulse is applied in a subfield to which a minimum gray-level weight is allocated or another subfield to which a second smallest gray-level weight is allocated, an application period of the first voltage may be longer than that of other subfields having higher gray-level weights, thereby reducing or preventing an instable sustain discharge due to insufficient priming particles of the discharge cells.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display panel having display electrodes, address electrodes crossing the display electrodes, and discharge cells in areas where the display electrodes cross the address electrodes, the discharge cells being divided into a plurality of discharge cell groups in a direction of the address electrodes to drive the plasma display panel in groups, the method comprising:
dividing a unit frame used to express an image into a plurality of subfields; and
dividing each subfield into:
a mixing drive period, including
group address periods in which a discharge cell is selected to be turned on from the discharge cell groups, and
group sustain periods in which a certain number of sustain discharges is performed between the group address periods, sustain discharges being performed by applying a sustain pulse alternating between a first voltage and a second voltage; and
a correction sustain period, in which the number of sustain discharges is corrected in the discharge cell groups so as to perform a sustain discharge in accordance with a gray-level weight allocated to each of the subfields throughout the subfields,
wherein an application period of the first voltage in group sustain periods of a subfield having a minimum gray-level weight is longer than an application period of the first voltage in group sustain periods of subfields having higher gray-level weights.

2. The method as claimed in claim 1, further comprising allocating an application period of the first voltage in the group sustain periods of a subfield having a second smallest gray-level weight to be longer than an application period of the first voltage in group sustain periods of subfields having higher gray-level weights.

3. The method as claimed in claim 1, further comprising, during the group sustain periods, alternately applying a sustain pulse having the second voltage and the first voltage to the display electrodes, and applying the second voltage to the address electrodes.

4. The method as claimed in claim 1, wherein the display electrodes include sustain electrodes and scan electrodes spaced apart from and parallel to each other, the method further including, during the group address periods:
sequentially applying a scan pulse having a third voltage and a fourth voltage having a lower electric potential than the third voltage to the scan electrodes of each of the discharge cell groups;
applying a positive fifth voltage to the sustain electrodes of each of the discharge cell groups; and
applying a display data signal having a positive sixth voltage to the address electrodes of each of the discharge cell groups in accordance with the scan pulse.

5. The method as claimed in claim 1, wherein the correction sustain period includes a common sustain period in which the same number of the sustain discharge is performed in each of the discharge cell groups, and a selection sustain period in which the sustain discharge is selectively performed in each of the discharge cell groups.

6. The method as claimed in claim 5, wherein the display electrodes include sustain electrodes and scan electrodes spaced apart from and parallel to each other, the method further comprising:
during the common sustain period,
applying a sustain pulse alternating between the first voltage and the second voltage to the scan electrodes of each of the discharge cell groups, and
applying a sustain pulse alternating between the second voltage and the first voltage to the sustain electrodes of each of the discharge cell groups; and
during the selection sustain period,
selectively applying the sustain pulse alternating between the first voltage and the second voltage to the scan electrodes of each of the discharge cell groups, and
applying the sustain pulse alternating between the second voltage and the first voltage to the sustain electrodes of each of the discharge cell groups.

7. The method as claimed in claim 5, wherein the display electrodes include sustain electrodes and scan electrodes spaced apart from and parallel to each other, the method further comprising:
during the selection sustain period,
applying the first voltage and a fourth voltage lower than the first voltage to the scan electrodes of the discharge cell group in which the sustain discharge is not selectively performed,
applying the sustain pulse alternating between the first voltage and the second voltage to the scan electrodes of the other discharge cell groups, and
applying the sustain pulse alternating between the second voltage and the first voltage to the sustain electrodes of each of the discharge cell groups; and
during the common sustain period,
applying the sustain pulse alternating between the first voltage and the second voltage to the scan electrodes of each of the discharge cell groups, and
applying the sustain pulse alternating between the second voltage and the first voltage to the sustain electrodes of each of the discharge cell groups.

8. The method as claimed in claim 5, wherein the common sustain period occurs after the selection sustain period.

9. The method as claimed in claim 5, wherein the common sustain period occurs before the selection sustain period.

10. The method as claimed in claim 1, wherein each of the subfields further comprises a reset period that initializes all the discharge cells before the mixing drive period.

11. The method as claimed in claim 1, wherein the display electrodes include sustain electrodes and scan electrodes spaced apart from and parallel to each other, the method further comprising, during the reset period:
applying a rising pulse that increases from the first voltage by a third voltage to a fourth voltage and a falling pulse that decreases from the first voltage to a fifth voltage to the scan electrodes of each of the discharge cell groups;
applying a positive sixth voltage to the sustain electrodes of each of the discharge cell groups when the falling pulse is applied; and
continuously applying the second voltage to the address electrodes.

12. The method as claimed in claim 1, wherein the second voltage is a ground voltage.

13. The method as claimed in claim 1, wherein the sustain discharge is performed once in the group sustain periods.

14. The method as claimed in claim 1, wherein the plurality of groups is two.

15. A method of driving a plasma display panel having display electrodes, address electrodes crossing the display electrodes, and discharge cells in areas where the display electrodes cross the address electrodes, the discharge cells being divided into a plurality of discharge cell groups in a direction of the address electrodes to drive the plasma display panel by the groups, the method comprising:
dividing a unit frame used to express an image into a plurality of subfields; and
dividing each subfield into
a mixing drive period including
group address periods in which a discharge cell is selected to be turned on from the discharge cell groups, and
group sustain periods in which a certain number of sustain discharges is performed between the group address periods, sustain discharges being performed by applying a sustain pulse alternating between a first voltage and a second voltage; and
a correction sustain period in which the number of sustain discharges is corrected by the discharge cell groups so as to perform a sustain discharge in accordance with a gray-level weight allocated to each of the subfields throughout the subfields, the correction sustain period including
a common sustain period in which the same number of the sustain discharge is performed in each of the discharge cell groups, and
a selection sustain period in which the sustain discharge is selectively performed in each of the discharge cell groups.

16. The method as claimed in claim 15, wherein the common sustain period occurs before the selection sustain period.

17. The method as claimed in claim 16, wherein the display electrodes include sustain electrodes and scan electrodes spaced apart from and parallel to each other, the method further comprising:
during the common sustain period
applying a sustain pulse alternating between the first voltage and the second voltage to the scan electrodes of each of the discharge cell groups, and
applying a sustain pulse alternating between the second voltage and the first voltage to the sustain electrodes of each of the discharge cell groups; and
during the selection sustain period,
selectively applying the sustain pulse alternating between the first voltage and the second voltage to the scan electrodes of each of the discharge cell groups, and
applying the sustain pulse alternating between the second voltage and the first voltage to the sustain electrodes of each of the discharge cell groups.

18. The method as claimed in claim 15, wherein the common sustain period occurs after the selection sustain period.

19. The method as claimed in claim 18, wherein the display electrodes include sustain electrodes and scan electrodes spaced apart from and parallel to each other, the method further comprising:
during the selection sustain period,
applying the first voltage and a fourth voltage lower than the first voltage to the scan electrodes of the discharge cell group in which the sustain discharge is not selectively performed,
applying the sustain pulse alternating between the first voltage and the second voltage to the scan electrodes of the other discharge cell groups, and
applying the sustain pulse alternating between the second voltage and the first voltage to the sustain electrodes of each of the discharge cell groups; and
during the common sustain period,
applying the sustain pulse alternating between the first voltage and the second voltage to the scan electrodes of each of the discharge cell groups, and
applying the sustain pulse alternating between the second voltage and the first voltage to the sustain electrodes of each of the discharge cell groups.

20. The method as claimed in claim 15, wherein the sustain discharge is performed once in the group sustain periods.
